(19) United States
(12) Patent Application Publication
(10) Pub. No.: US 2012/0224387 A1
(43) Pub. Date: Sep. 6, 2012

(54) LASER TRAINER CARTRIDGE

(76) Inventor: Larry E. Moore, Cottonwood, AZ (US)

(21) Appl. No.: 13/353,165

(22) Filed: Jan. 18, 2012

Related U.S. Application Data
(60) Provisional application No. 61/433,902, filed on Jan. 18, 2011.

(51) Int. Cl. H01S 3/00

(52) U.S. Cl. 362/553

(57) ABSTRACT

A cartridge laser trainer fits into a gun barrel and includes a backer, circuit and a laser. When the firing pin of the gun is activated it strikes the backer, which contacts the circuit and activates the laser. The cartridge laser trainer may also have one or more O-rings to keep it positioned properly in the gun barrel. Also disclosed are kits that contain (1) a plurality of sheaths and a cartridge laser trainer, or (2) a plurality of O-rings and a cartridge laser trainer. Each sheath or O-ring(s) is configured to be positioned in a particular-sized gun bore and is configured to receive a cartridge laser trainer. With a kit, a single cartridge laser trainer can be used with more than one size of gun bore.

### CROSS REFERENCE TO RELATED APPLICATIONS

This application claims priority to and incorporates by reference the disclosure of U.S. Provisional Patent Application No. 61/433,902 entitled LASER TRAINER CARTRIDGE AND LASER TRAINER TARGET, filed on Jan. 18, 2011. The disclosure of co-pending U.S. application Ser. No. ______ entitled “Laser Trainer Target” to Larry E. Moore, filed on Jan. 18, 2012 is incorporated herein by reference.

### FIELD OF THE INVENTION

The present invention relates to firearm training systems that do not require live ammunition.

### BACKGROUND OF THE INVENTION

Conventional firearm training can be dangerous, expensive (considering the prices for ammunition and replacement targets) and can only be performed in certain areas, such as shooting ranges. The present invention allows firearm training to be performed safely, inexpensively, and almost anywhere without the use of live ammunition.

### SUMMARY OF THE INVENTION

A laser trainer cartridge (or “laser cartridge” or “cartridge”) according to various aspects of the invention is configured to fit inside the chamber (or bore) of a firearm and includes a firing-pin activated switch to emit a laser light to indicate where a bullet would strike. Among other things, the laser trainer cartridge provides realistic firearms training, preferably allowing a user to practice tap, rack, bang and malfunction drills. The laser training cartridge can be configured to operate with essentially any desired firearm of any caliber.

The cartridge is preferably cylindrical with a cylindrical outer surface. One or more O-rings comprised of compressible material are positioned on the outer surface, entirely or partially around the cartridge, in order to center the cartridge snugly in the barrel of a gun. A kit of the cartridges may be provided wherein there is a different sized cartridge/O-ring combination for different calibers of guns (and the cartridges may all be the same size, with different O-rings for different gun calibers). Alternatively, a kit may include a single cartridge and different-sized O-rings, wherein each different sized O-ring or set of O-rings is sized to fit a particular caliber of gun. In that case, one or more O-rings can be positioned on the cartridge to enable the cartridge/O-ring combination to fit a particular caliber gun, and the O-ring(s) could be changed so the cartridge/O-ring combination would fit a different caliber gun.

Also disclosed is a sheath that may be used to fit a cartridge snugly into a gun bore. The sheath is preferably a hollow tube that receives and retains the cartridge. This can be accomplished in any suitable manner, such as by (1) the sheath having internal structures, such as flexible members, that retain the cartridge, (2) the sheath being shaped to retain the cartridge, or (3) the cartridge having an external structure, such as one or more of the previously described O-rings, which in this case would cause the cartridge to fit snugly inside the sheath.

The sheath has one or more O-rings positioned on its exterior surface that enable it to be fit snugly into the bore of a gun. A kit could contain a single cartridge and multiple sheaths. Each of the multiple sheaths preferably would have essentially the same interior diameter and each could receive and retain the single cartridge, and at least some (or all) of the sheaths would have different-sized O-rings on their exterior surface. Therefore, different sheaths would fit snugly in guns having different bore sizes. In this manner, a single cartridge can be used with guns having different, respective bore sizes by changing the sheath.

### BRIEF DESCRIPTION OF THE DRAWINGS

FIGS. 1-4 are perspective views of exemplary laser trainer cartridges of different sizes, wherein each is configured to fit in a different caliber firearm.

FIG. 5 depicts the laser trainer cartridge of FIG. 1 that is partially disassembled.

FIG. 6 is a perspective view showing the laser trainer cartridge of FIG. 1 positioned inside the barrel of a firearm.

FIG. 7 is an exploded, perspective view of a laser trainer cartridge in accordance with FIGS. 1-4.

FIG. 8 illustrates the separate components of a laser trainer cartridge according to the invention.

FIG. 9 depicts an exemplary circuit that may be utilized by the laser trainer cartridge of the invention.

FIGS. 10 and 11 illustrate the top and bottom trace patterns, respectively, on a printed wiring board including the circuit of FIG. 12.

FIG. 12 depicts a sheath according to an aspect of the invention.

### DETAILED DESCRIPTION OF THE INVENTION

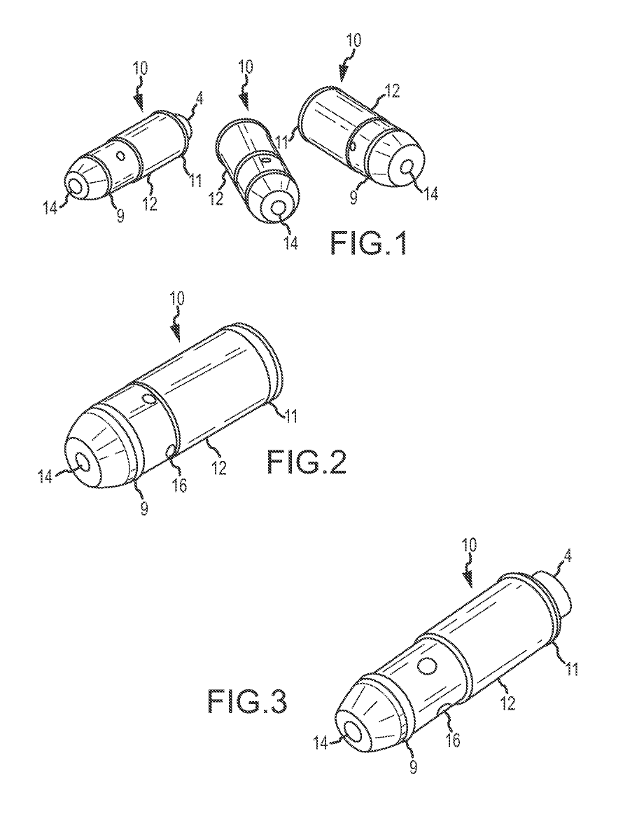

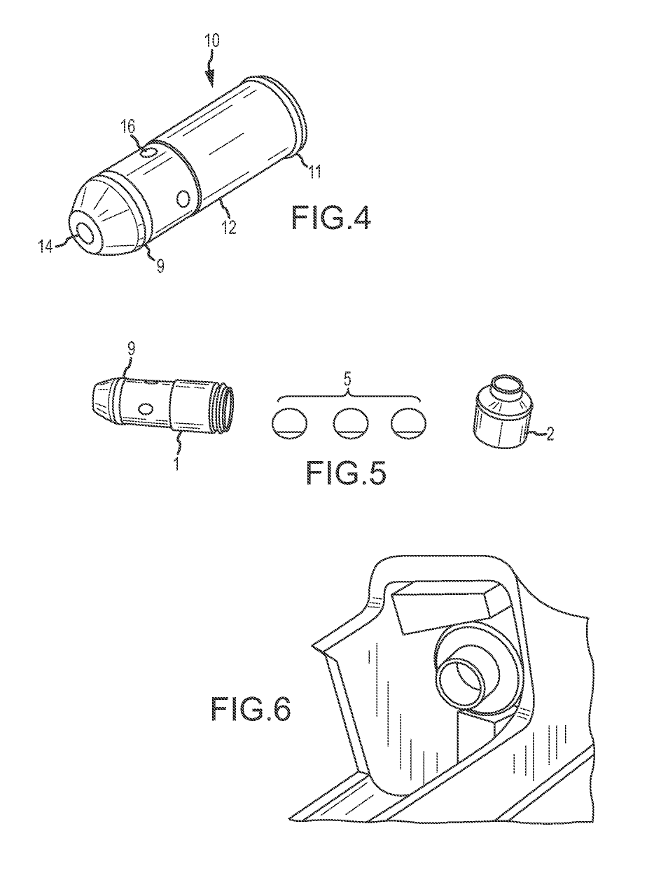

Turning now to the Figures, where the purpose is to describe preferred embodiments of the invention and not to limit same, the laser trainer cartridge 10 may be configured to operate in conjunction with firearms of essentially any desired caliber and regardless of the barrel length of the firearm. The only difference between the laser cartridges 10 shown in FIGS. 1-4 is their size. Each has the same structure as described herein.

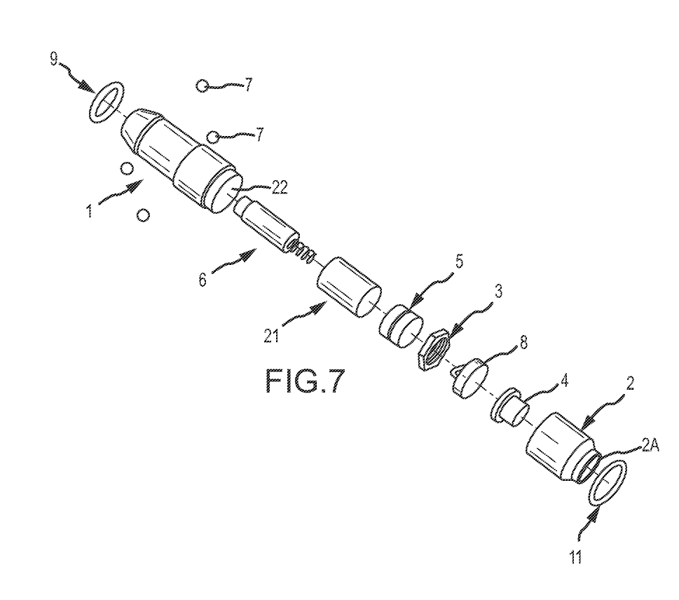

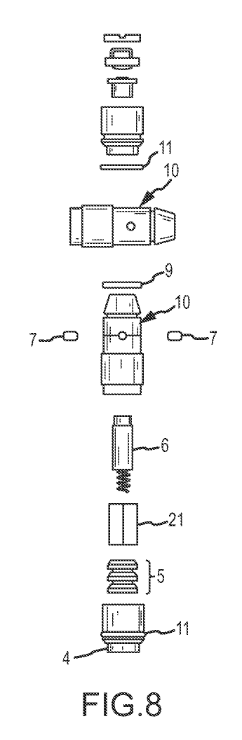

A cartridge 10 according to a preferred embodiment has a size and shape similar to a bullet. Cartridge 10 has an exterior surface 12, an opening 14 through which light is emitted, a removable backer 4, apertures 16 that house adjustment screws 7 that can adjust the position of laser module 6 (best seen in FIG. 7) that preferably emits visible, red laser light. In this embodiment, two O-rings 9 and 11 are positioned in grooves, or next to ridges, on exterior surface 12, and have an outer diameter greater than the outer diameter of cartridge 10.

In certain embodiments, a laser trainer cartridge 10 of the invention is configured to fit a firearm having a caliber of 9 mm, .32 cal, .38 cal, .40 cal., .44 cal., .45 cal, or .50 cal. The laser trainer cartridge 10 may be configured to fit snugly into the firing chamber (or bore) of essentially any desired firearm. The cartridge 10 is preferably configured so that it fits into the chamber of a gun in the same manner as a bullet.

The cartridge 10 is configured to emit light, which is preferably laser light, for any desired duration. In one embodiment, a laser trainer cartridge 10 includes a laser module 6, which in the preferred embodiment is a visible, red light laser module. In this embodiment, the laser module 6 activates for 100 milliseconds each time the firing pin strikes the backer 4 of cartridge 10, although any suitable activation duration can be selected. The laser trainer cartridge 10 is preferably rimless, so that it is not expelled during dry fire, which can allow for tap, rack, bang or malfunction training drills.

In one embodiment, a hardened rubber plunger (or backer 4) on the cartridge 10 also acts as a built-in snap cap to protect the firing pin of the gun when it strikes the backer 4. Backer 4 is thus pressure fit, or snap fit, into the end of cartridge 10 opposite opening 14 as cartridge 10 is assembled.

The cartridge 10 includes at least one rubber ring, which is preferably an O-ring, that is pressure fit onto the outer surface 12 of the cartridge 10, and most preferably two rubber O-rings are pressure fit onto surface 12. As shown, two rubber O-rings 9, 11 on the laser trainer cartridge 10 help ensure a snug fit in the gun bore. Front O-ring 9 is positioned on the front portion of cartridge 10, and rear O-ring 11 is positioned on the back portion of the cartridge 10. Among other things, the O-rings help to prevent the cartridge 10 from falling out of the gun, reduce vibration from the firing pin striking the backer 4, and retain the cartridge 10 in position while in use. The front O-ring 9 and rear O-ring 11 each preferably have a diameter equal to, or greater than, the diameter of the bore of the gun. In some embodiments, the front O-ring 9 and rear O-ring 11 have a diameter of equal to, or up to 0.030″ greater than, the diameter of the bore of the gun barrel in which cartridge 10 is used. The O-rings 9 and 11 may be any size, shape, and configuration, and may be formed from any suitable material to allow cartridge 10 to fit snugly in the bore of a firearm and help reduce vibration and movement when the backing 4 of cartridge 10 is struck by the firing pin.

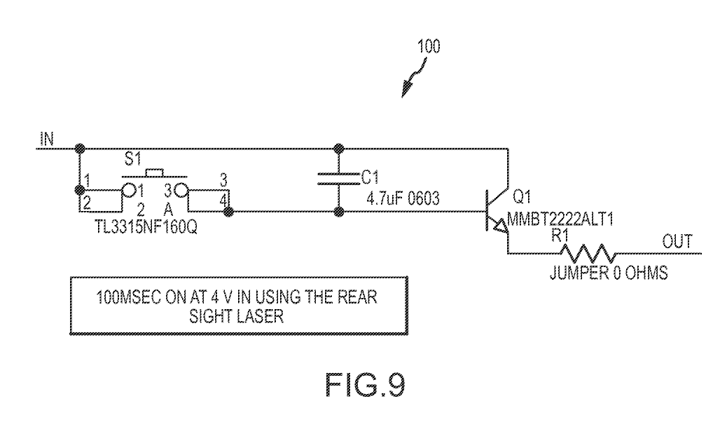

In one embodiment, the laser trainer cartridge is powered by three 377-type batteries 5 (shown in FIGS. 7 and 9) that fit in an internal cavity 22 of the laser trainer cartridge 10 to provide power to a circuit 8 (such as the exemplary circuit in FIG. 9), which utilizes 4-4.5 V. In this embodiment, the batteries 5 provide enough power for approximately 3,000 emissions of laser light that simulate a bullet being fired.

FIG. 7 depicts an exploded view of an exemplary laser trainer cartridge 10 according to various aspects of the invention. In this embodiment, the laser trainer cartridge 10 includes an outer casing formed by components 1 and 2. A backer 4 in the exemplary embodiment of FIG. 7 is positioned at the rear of the cartridge 10 so it can be struck by the firing pin of the gun when the gun is fired (i.e., when a user pulls the trigger of the gun). The backer 4 has a first position where it is not in contact with a circuit 8 and a second position where the backer 4 contacts the circuit 8. When assembled, backer 4 can be struck by the firing pin of a gun through opening 2A of body portion 2. When the backer 4 is struck by the firing pin of the gun, the backer moves from the first position to the second position, and the circuit 8 causes the laser module 6 to illuminate.

The backer 4 may be of any suitable size, shape, and configuration, and may be formed from any suitable material. In one exemplary embodiment, the backer 4 is formed from urethane. In one embodiment, the material forming the backer is urethane having a durometer of about 85 Shore A. In alternate embodiments, the backer has a durometer of between about 75 and about 95 Shore A.

The batteries 5 are preferably insulated from the body of the cartridge 10 by a mylar sleeve 21. The laser module 6 may be of any suitable size, shape, and configuration, and may emit light of any desired shape, intensity, and color.

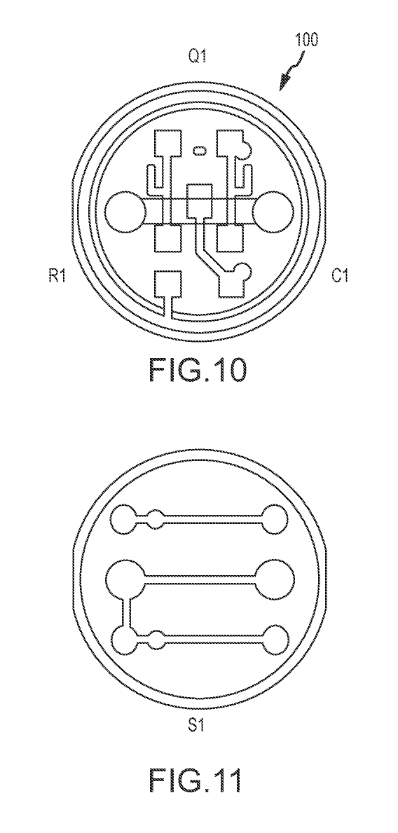

FIGS. 10-11 depict an exemplary circuitry 100 that may be implemented in circuit 8 of FIG. 10. In this circuitry 100, the backer moving to its second position actuates the switch 51, which in turn discharges capacitor C1 through transistor Q1 in order to cause laser module 6 to illuminate for a predetermined period of time. In this embodiment, the circuitry 100 in FIG. 9 is implemented using a printed circuit board having the trace diagrams illustrated in FIGS. 10 and 11. Alternate embodiments of the invention may utilize any other suitable circuit to cause the laser module 6 to illuminate.

The circuitry 100 may be configured to cause the laser module 6 to illuminate for any desired length of time. In one embodiment, the laser is illuminated for between about 7.5 milliseconds (ms) to about 12.5 ms per shot, i.e., each time the firing pin contacts the backer 4 of cartridge 10.

A plurality of different cartridges sized to fit different-sized gun bores may be sold as a kit. Alternatively, a kit may include one or more cartridges of the same or different sizes along with different-sized O-rings. Each different sized O-ring(s) can be placed on a cartridge in order to configure it to fit a particular caliber of gun, and O-ring(s) can be removed and replaced with other O-rings in order to change the size of the gun bore into which the cartridge fits.

In one embodiment of the present invention, a laser trainer cartridge of the present invention may be configured to fit into an adapter sheath (or “sheath”) 200.

Among other things, the sheath 200 acts as an adapter to allow a laser trainer cartridge 10 to operate in a firearm having a different caliber than the laser trainer cartridge 10 itself is designed to operate. For example, a laser trainer cartridge 10 configured to fit in a .32 caliber firearm may be sold as a kit with a plurality of adapter sheaths 200 that allow the cartridge to be used with larger-caliber firearms (e.g., .38 caliber, .40 caliber, .44 caliber, etc.).

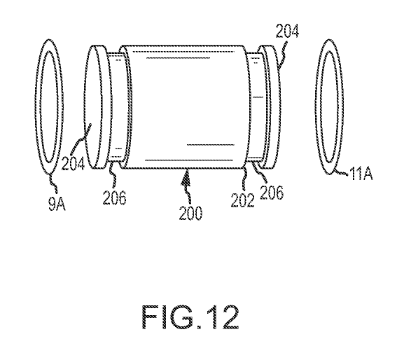

As shown in FIG. 12, in one embodiment, an adapter sheath 200 has a generally cylindrical body configured to fit into a particular sized firearm. The sheath 200 is preferably at least partially open at both ends to allow the cartridge 10 to be inserted into and retained in the sheath cavity 204, and to allow light from laser module 6 to be emitted, and the firing pin to strike the backing 4 of the cartridge 10.

Adapter sheath 200 preferably includes at least one O-ring on its exterior surface 202 that has a diameter equal to, or greater than, the diameter of the gun bore into which the sheath 200 is configured to fit. The O-ring for the sheath can be any type of structure as the O-rings previously described for cartridge 10.

In one embodiment, a sheath 200 of the present invention includes two O-rings 9A, 11A; one positioned at either end of sheath 200 in grooves 206, and each O-ring 9A, 11A has a diameter equal to, or up to 0.030″ greater than, the diameter of the gun bore. As with the O-rings of the cartridge described previously, these O-rings form a snug fit with the gun bore to help prevent the sheath/cartridge combination from falling out of the firearm, as well as to reduce vibration from the firing pin hitting the back of the cartridge 10 and to retain the sheath/cartridge combination in place during use.

The cartridge 10 can be retained inside the sheath 200 in any suitable manner. In one embodiment, the O-rings 9 and 11 of cartridge 10 are sized to interface with the interior surface of the sheath 200 to help retain cartridge 10 within cavity 204 of sheath 200. In another embodiment, the front portion of the sheath includes a lip or narrowed portion that prevents the cartridge 10 from passing through the front of the sheath, yet does not occlude or interfere with the light emitted from the laser module 6. Any other structure(s) may be used in conjunction with the present invention to retain the laser trainer cartridge 10 within the sheath 200.

In some embodiments, the cartridge 10 may be configured to produce a sound (e.g., a gunshot sound) when the firing pin strikes the backer. The cartridge may include a speaker or any other suitable device to produce a sound, and may produce any desired sound.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A cartridge laser trainer comprising a generally cylindrical outer casing including one or more O-rings, the cartridge laser trainer configured to fit snugly within a gun barrel of a particular diameter, and a backer that is positioned so as to be struck by a firing pin of the gun when the gun is fired, a circuit and a laser, wherein the backer has a first position wherein it does not contact the circuit and a second position wherein it contacts the circuit, the backer moving from its first position to its second position when it is struck by the firing pin, and the circuit causing the laser to illuminate when it is contacted by the backer.

2. The cartridge laser trainer of claim 1 wherein the backer is comprised of urethane.

3. The cartridge laser trainer of either claim 2 wherein the backer has a durometer of between about 75 to about 95 Shore A.

4. The cartridge of laser trainer of claim 1 wherein the circuit includes a capacitor.

5. The cartridge laser trainer of claim 1 that is battery powered.

6. The cartridge laser trainer of claim 5 that includes three batteries.

7. The cartridge laser trainer of claim 1 wherein the laser is activated for between about 7.5 to about 12.5 milliseconds when the circuit is activated.

8. The cartridge laser trainer of claim 1 wherein the circuit is a 4.5 V system.

9. The cartridge laser trainer of claim 1 that includes a front portion and a front O-ring positioned on the front portion, the front O-ring having an outer diameter equal to or greater than the interior diameter of the bore of the gun barrel so as to create a snug fit.

10. The cartridge laser trainer of claim 9 wherein the front O-ring has a diameter between the internal diameter of the gun barrel to 0.030″ greater than the internal diameter of the gun barrel.

11. The cartridge laser trainer of claim 9 that includes a back portion and a rear O-ring positioned on the back portion, the rear O-ring having an outer diameter equal to or greater than the interior diameter of the bore of the gun barrel so as to create a snug fit.

12. The cartridge laser trainer of claim 11 wherein the rear O-ring has an outer diameter between the internal diameter of the gun barrel and 0.030″ greater than the internal diameter of the gun barrel.

13. The cartridge laser trainer of claim 1 that is dimensioned to be received in either a 9 mm, .32 caliber, .38 caliber, .40 caliber, .44 caliber, .45 caliber or .50 caliber gun.

14. A kit comprising the cartridge laser trainer of claim 1 and a plurality of sheaths, wherein each of the sheaths has a generally cylindrical body and one or more O-rings, each sheath being configured to fit into a gun barrel of a particular diameter.

15. The kit of claim 14 wherein each sheath is configured to fit into a different sized gun barrel.

16. The kit of claim 14 wherein each sheath has a first end and a second end, the first end being open and the second end being open.

17. The kit of claim 14 wherein each sheath has an O-ring on its outer surface, the O-ring having a diameter equal to or greater than the diameter of the gun barrel into which the sheath is configured to be used.

18. The kit of claim 17 wherein the O-ring has a diameter equal to, or up to 0.030″ greater than, the diameter of the gun barrel into which the sheath is configured to be used.

19. The kit of claim 14 wherein each sheath has a first portion having a first O-ring and a second portion having a second O-ring, the first O-ring having a diameter equal to or greater than the diameter of the gun barrel into which the sheath is configured to be received, and the second O-ring having a diameter equal to or greater than the diameter of the gun barrel into which the sheath is configured to be used.

20. The kit of claim 19 wherein the first O-ring has a diameter of equal to, or up to 0.030″ greater than, the gun barrel into which the sheath is configured to be used, and the second O-ring has a diameter of equal to, or up to 0.030″ greater than the gun barrel into which the sheath is configured to be used.

21. The kit of claim 14 wherein the cartridge laser trainer is retained in the sheath by one or more O-rings on the cartridge laser trainer.

22. A cartridge laser trainer comprising a generally cylindrical outer casing including one or more O-rings, the cartridge laser trainer configured to fit snugly within a gun barrel of a particular diameter, and a backer that is positioned so as to be struck by a firing pin of the gun when the gun is fired, a circuit and a laser, wherein the backer has a first position wherein it does not contact the circuit and a second position wherein it contacts the circuit, the backer moving from its first position to its second position when it is struck by the firing pin, and the circuit causing the laser to illuminate when it is contacted by the backer.
